(19) United States
(12) Patent Application Publication
(10) Pub. No.: US 2010/0211921 A1
(43) Pub. Date: Aug. 19, 2010

(54) DEVELOPMENT VERIFICATION APPARATUS FOR UNIVERSAL CHIP

(75) Inventors: Bo Hu, Beijing (CN); Zhenfeng Zhao, Beijing (CN); DaYong Yu, Beijing (CN)

Correspondence Address: TUROCY & WATSON, LLP, 127 Public Square, 57th Floor, Key Tower, CLEVELAND, OH, 44114, US

(73) Assignee: Beijing Transpacific IP Technology Development Ltd, Beijing (CN)

(21) Appl. No.: 12/602,014

(22) PCT Filed: May 26, 2008
(86) PCT No.: PCT/CN08/71090

§ 371 Date: Apr. 13, 2010

(30) Foreign Application Priority Data
May 31, 2007 (CN) 200720149395.7

(51) Int. Cl. G06F 17/50

(52) U.S. Cl. 716/5

(57) ABSTRACT

A development verification apparatus for verification of universal chips, including an object design module for storing and executing the object code of the chip to be verified, a control processing module for executing the control program etc. of the user of the development verification apparatus, a power management module for managing the power and charging the battery, and an extended function module for implementing developing function in various fields.

### BACKGROUND OF THE INVENTION

1. Field of the Invention

The present invention relates to a development verification apparatus for universal chip, and more particularly relates to a universal, high speed, elastic and extendable development verification platform for chip of the integrated circuit, which belongs to the field of the chip design.

2. Description of the Prior Art

The general way to develop a chip is to complete the initial objective design on the field programmable gate array (FPGA), and then convert it into an application specific integrated circuit (ASIC) after verification, test and correction processes until the performance satisfies the design requirements. It is very expensive to produce the ASIC, so the verification must be fully carried out by the FPGA to eliminate all potential problems before entering the ASIC producing stage. Therefore, a stable and powerful FPGA development verification apparatus is needed to support the object design and ensure the design, verification and test workflows running smoothly. All kinds of intellectual property cores are designed in this way, as well as the system-on-chip (SOC).

As shown in FIG. 1, the fundamental structure of a traditional development verification apparatus includes a FPGA 104, a peripheral circuit 102 and a simple power controller 106. The external ports of the peripheral circuit 102 are deposited on a single motherboard, allowing some simple function blocks to be extended externally.

The structure of the traditional is very simple, for each function block is unique and cannot be changed. Consequently, to be adaptable for various designs of different complexity, a lot of different types of development verification platform are required.

Meanwhile, a user may have following requirements in design:

1. The design capacities vary from different object chips, and the scale of a FPGA should be selectable for the purpose of cost reduction.

2. The development verification platform is expected to posses not only a FPGA of proper capacity but external devices of particular functions to carry out auxiliary design.

3. As for the design of the intellectual property core or the SOC that needs to work cooperatively, significant amount of extended interfaces are needed due to the uncertainty of external working conditions, whereby various requirements in designing the extended board can be fulfilled.

4. The ability of the development verification platform as well as its computation resource is too limited to serve as an embedded system. To make the best use of the computation resource of a computer, the connectivity to the computer is beneficial for either verification or test processes. Nevertheless, the connection speed is expected to be fast enough for real-time applications.

### SUMMARY OF THE INVENTION

The present invention provide a development verification apparatus for universal chip, whose cascade structure connected with the universal interfaces provides the flexibility for users during the development, so that different users can select the most suitable development system to save cost.

The development verification apparatus for universal chip includes:

an object design module, for storing and executing an object code of the chip to be verified, and separately connected to a control processing module and a extended function module via two universal interfaces;

the control processing module, for executing the control program of the user of the development verification apparatus, establishing a data channel between the object design module and a computer that controls the process of the verification and displays a verification result, and generating an excitation signal that activates the object code;

a power management module, for providing the power to the development verification apparatus;

the extended function module, for establishing the data channel between the object design module and an external test equipment; and

the computer, for inputting the control program of the user of the development verification apparatus and displaying the verification result of the development verification apparatus, and connected to the control processing module via a serial port and connected to the object design module via a universal serial data bus.

The object design module in said development verification apparatus includes:

a field programmable gate array (FPGA), for executing the object code of the chip to be verified;

a configuration memory, for storing the object code of the chip to be verified, and connected to the FPGA;

the USB, for the data communication between the computer and the object design module;

a clock, for generating a clock signal for the object code, and connected to the FPGA; and

the universal interface, for the signal communication between the object design module and other function modules.

The control processing module in said development verification apparatus includes:

a microprocessor, for executing the control program of the user of the development verification apparatus and controlling the data communication with the computer, and connected to the computer via a serial port;

the serial port, for the communication between the microprocessor and the computer, and connected to the microprocessor and the computer; and

the universal interface, for the communication between the control processing module and other function modules.

The power management module in said verification apparatus includes:

a lithium battery, for supplying the power to the development verification apparatus;

a buck direct current (DC) switching power converter, for outputting a voltage lower than the lowest voltage of the battery to supply the power for the core of the FPGA;

a boost DC switching power converter, for outputting a voltage higher than the highest voltage of the battery to supply the power for the peripheral circuits;

a buck-boost DC switching power converter, for outputting a voltage between cooperation the lowest voltage and the highest voltage of the battery to supply the power for the gate circuit interface of the FPGA and the microprocessor; and

a battery charging circuit, for charging the lithium battery.

The extended function module in said development verification apparatus includes:

a radio frequency (RF) transceiver circuit, for transmitting and receiving a wireless test signal, in which the test signal generated by the object code is transmitted to the RF transceiver circuit after the digital-to-analog (D/A) conversion and then sends out a RF signal after the modulation;

an analog-to-digital and digital-to-analog converter, for the conversion between the analog signal of the RF transceiver circuit and the digital signal of the object design module, and connected to the RF transceiver circuit and the object design module; and

the universal interface, for the signal connection between the extended function module and other function modules,

wherein the received RF signal is sent to the object design module through the D/A converter after the demodulation.

The development verification apparatus has following advantages:

1. Extendibility. The object design module and the control processing module separately integrate the circuits around the FPGA and the microprocessor, so that the capacity of the FPGA can be adjusted according to the design and cooperated with the replaceable extended function module to accomplish the design, the assessment, and the test of various complicated chips.

2. Universality. The object design module and the control processing module are used together to accomplish the design, the assessment, and the test of chips. For developing different functions, different extended function modules are applied without changing the basic platform to realize the universality.

3. High speed data exchange between the object design and the computer. The USB establishes high speed data channel with the computer, and users can finish most of the work in advance on the computer through the interface so as to complete the original design quickly. After the design is completed, the computer can be used to generate the test excitation signal to facilitate the verification of the design.

4. Strong power management function. Lithium battery is used to supply the power, and the wide range of the battery input can make the battery exert the maximum efficiency, and the battery can also supply the power directly for all kinds of environments.

### BRIEF DESCRIPTION OF THE DRAWINGS

FIG. 1 is a structural diagram of a conventional development verification apparatus for chip.

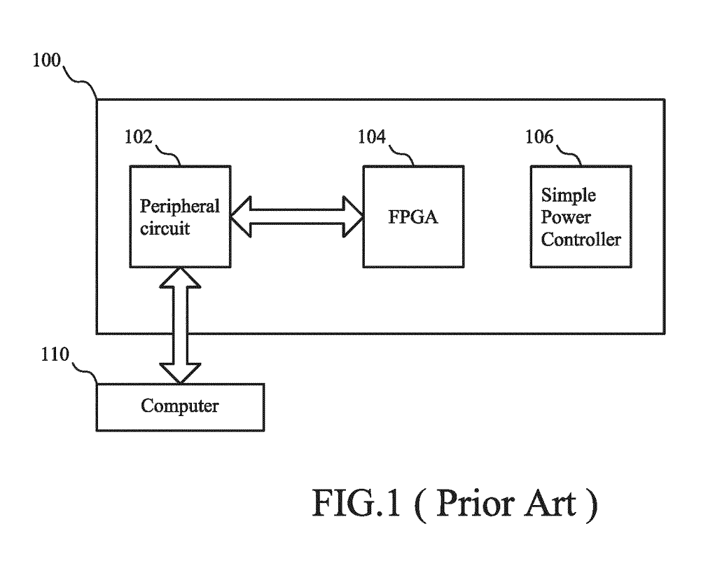

FIG. 2 is a structural diagram of the present development verification apparatus for universal chip.

FIG. 3 is a circuit diagram of the object design module of the present development verification apparatus.

FIG. 4 is a circuit diagram of the control processing module of the present development verification apparatus.

FIG. 5 is a circuit diagram of the power management module of the present development verification apparatus.

FIG. 6 is a schematic view of the extended function module of the present development verification apparatus.

### DESCRIPTION OF THE PREFERRED EMBODIMENTS

It is to be understood that other embodiments may be utilized and structural changes may be made without departing from the scope of the present invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” and “coupled,” and variations thereof herein are used broadly and encompass direct and indirect connections, couplings, and mountings.

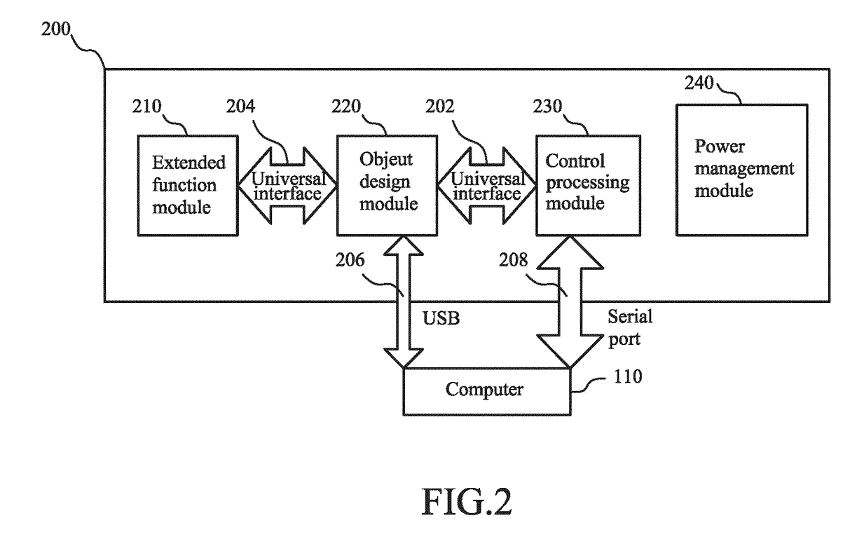

The structural diagram of a development verification apparatus for universal chip is shown in FIG. 2. The development verification apparatus includes: an object design module 220 storing and executing an object code of the chip to be verified; a control processing module 230 executing the control program and establishing a data channel (e.g. a USB connection 206) between the object design module 220 and a computer 110; a power management module 240 powering the development verification apparatus; an extended function module 210 establishing the data channel between the object design module 220 and an external test equipment; the computer 110 providing the control program to the object design module 220, displaying the verification result of the development verification apparatus, controlling the progress of verification and generating an excitation signal to activate the object code.

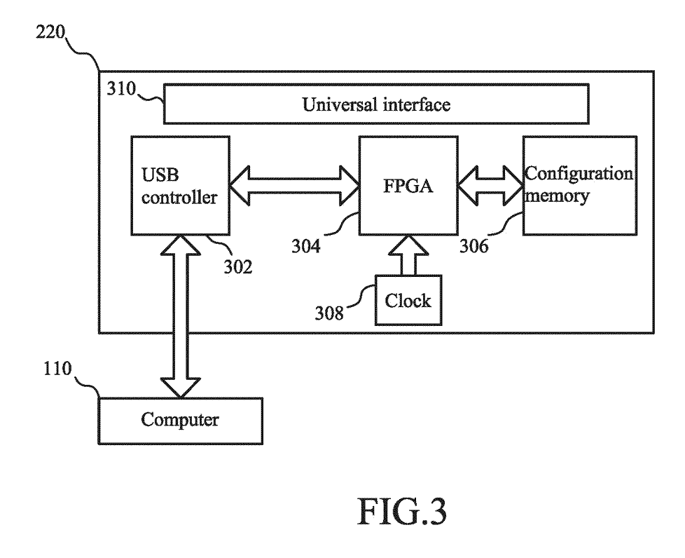

The object design module 220 of said development verification apparatus, as shown in FIG. 3, includes: a field programmable gate array (FPGA) 304, for executing the object code of the chip to be verified; a configuration memory, for storing the object code of the chip to be verified, and connected to the FPGA 304; the universal serial bus (USB) controller 302 controlling a USB connection 206 between the computer 110 and the object design module 220; a clock 308, connected to the FPGA 304 for generating a clock signal for the object code; the universal interface 310, for the signal connection between the object design module 220 and other function modules. In the preferred embodiment, the object design module 220 is designed with the FPGA 304 as its center. The FPGA 304 and the auxiliary circuit thereof include a SpartenIII serial FPGA of XILINX Corporation with a selectable capacity from 200 thousands to 1 million gates, a configuration memory (1M/2M/4M) 306, a global clock input and the universal interface 310. The user can select a suitable FPGA according to desired capacity to be beneficial for cost saving. If a FPGA of higher capacity is needed, a higher level object design module can be used without changing other function modules to save cost. The type of the configuration memory 306 is XCF01S/XCF02S/XCF04S and is for configuring the FPGA 304. The global clock input is provided from a clock 308 to the FPGA 304. The universal interface 310 is for the signal communication with other function modules for data exchange.

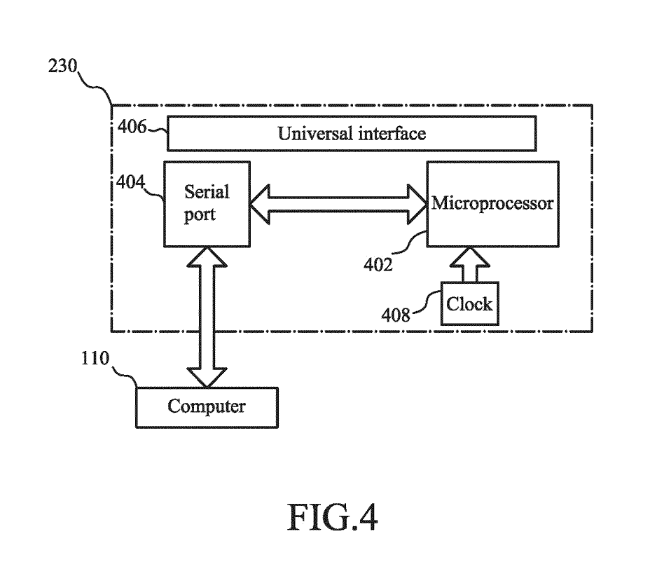

The control processing module 230 in the development verification apparatus, as shown in FIG. 4, includes: a microprocessor 402, for executing the control program of the development verification apparatus and controlling the data communication with the computer 110, and connected to the computer 110 via the serial port 404; the serial port 404, for the communication between the microprocessor and the computer 110, and connected to the microprocessor 402 and the computer 110; the universal interface 406, for controlling the signal communication between the control processing module 230 and other function modules. In the preferred embodiment, the microprocessor 402 and the auxiliary circuit thereof include a C8051F120 processor as the microprocessor 402 for executing the control program. The microprocessor 402 is connected to the FPGA 304 of the object design module 220 via the universal interface 406 to realize the real-time software and the system simulation. The microprocessor 402 can be used as a simple external simulation and an evaluation platform by sending the test data to the FPGA 304 and receiving the output data from the FPGA 304. The microprocessor 402 plays an important role in speeding up the design progress and the test process. The simulation and evaluation ability of the microprocessor 402 is not enough, so the microprocessor 402 can connect to the computer 110 via the serial port 404 and use the high speed computation ability of the computer 110 to satisfy the need of the design and the test. Moreover, the computer 110 is the most familiar development platform to the developers to reduce the training time and to accelerate the design progress. The serial port 404 is for the communication with the computer 110. The serial port 404 driver chip is SP3232. The universal interface 406 is for the signal communication with other function modules so as to complete the data exchange.

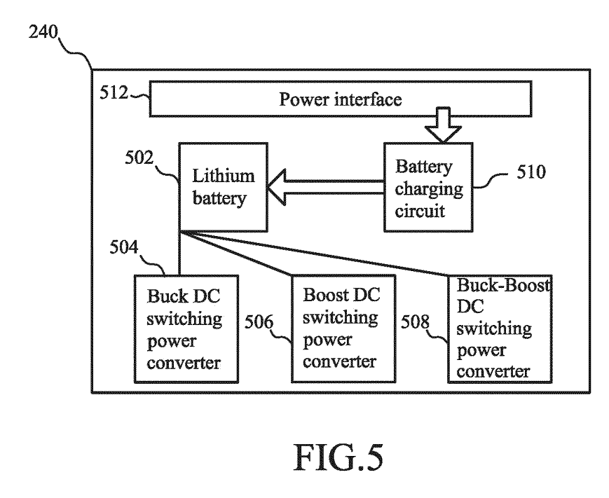

The power management module 240 of the development verification apparatus, as shown in FIG. 5, includes: a lithium battery 502, for supplying power to the development verification apparatus; a buck direct current (DC) switching power converter 504, for outputting a voltage lower than the lowest voltage of the battery and powering the FPGA 304; a boost DC switching power converter 506, for outputting a voltage higher than the highest voltage of the battery and supplying power to a peripheral circuit; a buck-boost DC switching power converter 508, for outputting the voltage between the lowest voltage and the highest voltage of the battery and powering the FPGA 304 and the microprocessor 402; a battery charging circuit 510, for charging the lithium battery 502. In a preferred embodiment, the power management module 240 and the auxiliary circuit thereof include the buck DC switching power converter 504 using a TPS62040 chip of Texas Instruments (TI), the boost DC switching power converter 506 using a TPS61032 chip of TI, the buck-boost DC switching power converter 580 using a TPS63000 chip of TI and the battery charging circuit 510 charging the Lithium battery 502 of a single type or a polymer type. The Lithium battery 502 may be a BQ24001 chip of TI for powering the development verification apparatus.

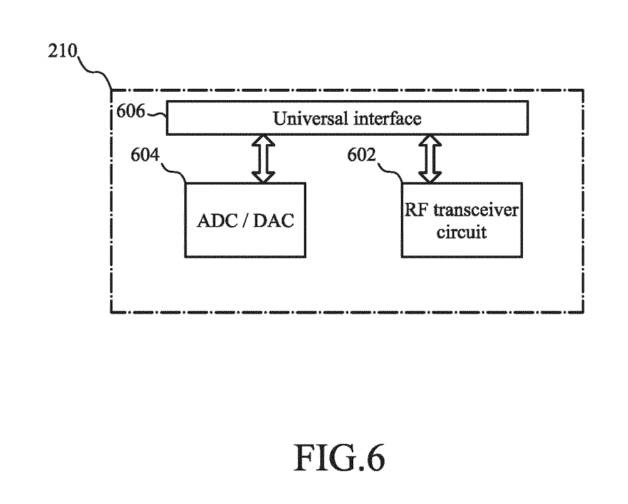

The extended function circuit module 210 of the development verification apparatus, as shown in FIG. 6, includes: a radio frequency (RF) transceiver circuit, for transmitting and receiving a wireless test signal generated from the object code. The wireless test signal is sent to the RF transceiver circuit after the digital to analog conversion, and then transmitted after being modulated; an analog-to-digital and digital-to-analog converter (ADC/DAC) 604, for converting to and from between analog signals in the RF transceiver circuit and digital signals in the object design module 220, and connected to the RF transceiver circuit and the object design module 220; the universal interface 606 controls connections between the extended function module 210 and other function modules, wherein a received RF signal is sent to the object design module 220 through the ADC/DAC 604 after demodulation. The analog-to-digital part of the ADC/DAC 604 may be an AD9201 chip manufactured by ADI®, converting analog signals from the RF transceiver circuit 602 into digital signals which can be recognized by the FPGA 304, and sending the digital signals to the object design module 220. The digital-to-analog part of the ADC/DAC 604 may be an AD9761 chip manufactured by the ADI corp., for converting the output digital signals from the object design module 220 into analog signals which can be recognized by the RF transceiver circuit 602. The RF transceiver circuit 602 is for transmitting and receiving the wireless test signal. The test signal is generated by the object code, sent to the RF transceiver circuit 602 after the digital-to-analog conversion, and then transmitted after being modulated. The RF transceiver circuit 602 may adapt a AD8349 chip manufactured by the ADI corp. for signal modulation and transmission. Conversely, a received RF signal is transmitted to the object design module 220 through the ADC/DAC 604 after demodulation, and the signal reception and demodulation may be performed by an AD8347 chip manufactured by the ADI corp. The universal interface 606 is for the signal communication between the extended function module 210 and other function modules for data exchange.

The development verification apparatus applies the cascade structure. Each function module is independent and can be combined freely, and the extended module with different function can also be used if necessary.

Because of the various object designs, the method for the development verification and the used resource are various. Only one or several parts of the present development verification apparatus is used so unable to provide all embodiments of the design here.

To establish a work environment for the wireless data transmission and reception, the extended function module 210 is designed with the ADC/DAC 604 and the RF transceiver circuit 602. The extended function module 210 together with the object design module 220, the control processing module 230 and the power management module 240 jointly constitute a wireless transceiver system.

Display and control programs for transceived data are executed on the computer 110. The control program is executed by the microprocessor 402 of the control processing module 230. The object code, also referred to as the IP core, is realized in the FPGA 304 of the object design module 220.

The work process is described as follows:

Data Transmission Process:

1. The computer 110 sends the excitation signal of the object code to the microprocessor 402 of the control processing module 230 via the serial port 404.

2. After the microprocessor 402 receives the excitation signal that activates the object code, the excitation signal is processed by the control program and sent to the FPGA 304 of the object design module 220 via the universal interface.

3. The FPGA 304 processes the object code in response to the excitation signal, and transmits the wireless test signal via the D/A converter and the RF transmitter.

Data Receiving Process:

1. The wireless test signal is decoded into the object code and sent to the FPGA 304 after received by the RF transmitter and the A/D converter, and the object code is processed to generate a verification result that is then sent to the microprocessor 402 of the control processing module 230 via the universal interface.

2. The microprocessor 402 receives the verification result and sends the verification result to the computer 110 via the serial port 404.

3. After receiving the verification result, the computer 110 processes the verification result and displays the results.

Support of the Present Development Verification Apparatus in the Development Stage:

The ultimate design object is the object code in the FPGA 304. The object code is a part of the data stream, and can be relative simple or complicated.

Support of the Present Development Verification Apparatus in the Verification Stage:

The verification of the object design needs a lot of excitation signals. In the conventional development verification structure, hardware description language is usually used in the FPGA 304 to generate the excitation signal. In the present development verification apparatus, said method can also be adopted. Meanwhile, another choice is also provided, say, the excitation signal can also be generated by the computer 110. The computer 110 sends the excitation signal to the microprocessor 402 via the serial port 404 and then the microprocessor 402 applies the excitation signal to the FPGA 304. Said method is more flexible than the conventional method, and users can change the excitation signal at any time without changing the object design so as to complete the verification process efficiently.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

What is claimed is:

1. A development verification apparatus for verifying universal chips, comprising:
an object design module, for storing and executing an object code of a chip to be verified;
a control processing module, coupled to the object design module via a first universal interface, for executing a control program to establish data channels between the object design module and a computer, and generate an excitation signal for activating the object code;
a power management module, for supplying power to the development verification apparatus;
an extended function module, coupled to the object design module via a second universal interface, for establishing data channels between the object design module and an external test equipment; and
the computer, coupled to the control processing module via a serial port, and coupled to the object design module through a universal serial bus (USB) for providing the control program, controlling a progress of verification and displaying a verification result.

2. The development verification apparatus of claim 1, wherein the object design module comprises:
a field programmable gate array (FPGA), for executing the object code of the chip to be verified;
a configuration memory, connected to the FPGA, for storing the object code of the chip to be verified;
a USB controller, coupled to the computer via the USB for control of data transmission between the computer and the object design module;
a clock, connected to the FPGA for generating a clock signal for execution of the object code; and
one or more universal interfaces, for controlling data transmissions between the object design module and other function modules.

3. The development verification apparatus of claim 1, wherein the control processing module comprises:
a microprocessor, connected to the computer via a serial port, for executing the control program and communicating with the computer;
the serial port, connected to the microprocessor and the computer for controlling communications therebetween; and
the first universal interface, controlling communications between the control processing module and other function modules.

4. The development verification apparatus of claim 1, wherein the power management module comprises:
a lithium battery, for powering the development verification apparatus;
a buck direct current (DC) switching power converter, for outputting a voltage lower than the lowest voltage of the lithium battery to power the FPGA;
a boost DC switching power converter, for outputting a voltage higher than the highest voltage of the lithium battery to power a peripheral circuit;
a buck-boost DC switching power converter, for outputting a voltage between the lowest voltage and the highest voltage of the lithium battery to power the FPGA and the microprocessor; and
a battery charging circuit, for charging the lithium battery.

5. The development verification apparatus of claim 1, wherein the extended function module comprises:
a radio frequency (RF) transceiver circuit for signal transmission and reception;
an analog-to-digital and digital-to-analog converter (ADC/DAC), connected to the radio frequency transceiver circuit and the object design module for converting to and from between analog signals in the radio frequency transceiver circuit and digital signals in the object design module; and
the second universal interface, controlling signal communications between the extended function module and other function modules, wherein:
a wireless test signal generated from the object code, is digital-to-analog converted by the ADC/DAC, and modulated and transmitted by the radio frequency transceiver circuit; and
a radio frequency signal received by the RF transceiver circuit is demodulated, analog-to-digital converted by the ADC/DAC, and sent to the object design module.
